(19) United States
(12) Patent Application Publication
(10) Pub. No.: US 2025/0041670 A1
(43) Pub. Date: Feb. 6, 2025

(54) GOLF BALL

(71) Applicant: Sumitomo Rubber Industries, Ltd., Kobe-shi (JP)

(72) Inventors: Hidetaka INOUE, Kobe-shi (JP); Kaita FUKAO, Kobe-shi (JP)

(73) Assignee: Sumitomo Rubber Industries, Ltd., Kobe-shi (JP)

(21) Appl. No.: 18/787,426

(22) Filed: Jul. 29, 2024

(30) Foreign Application Priority Data
Aug. 3, 2023 (JP) 2023-127133

(51) Int. Cl. A63B 37/00; C08L 9/00

(52) U.S. Cl. CPC A63B 37/0075; A63B 37/0031; A63B 37/0043; A63B 37/00621; A63B 37/0063; A63B 37/00922; C08L 9/00

(57) ABSTRACT

An object of the present disclosure is to provide a golf ball having improved controllability on iron shots. The present disclosure provides a golf ball 2 comprising a spherical core 4, an intermediate layer 6 and an outermost cover 8, wherein the spherical core 4 is formed from a rubber composition containing a polybutadiene rubber and a butyl rubber in a predetermined amount, a center hardness (H0) of the spherical core 4 and hardnesses (H_{2.5}, H_{5.0}, H_{7.5}, H₁₀, H_{12.5}, H₁₅) at points having a radial distance of 2.5 mm, 5.0 mm, 7.5 mm, 10 mm, 12.5 mm, 15 mm from a center of the spherical core satisfy a relationship of H0<H_{2.5}<H_{5.0}<H_{7.5}<H₁₀<H_{12.5}<H₁₅, a hardness difference (H₁₀−H0) is 10 or more in Shore C hardness, and a slab hardness of an intermediate layer composition forming the intermediate layer 6 is greater than a slab hardness of a cover composition forming the outermost cover 8.

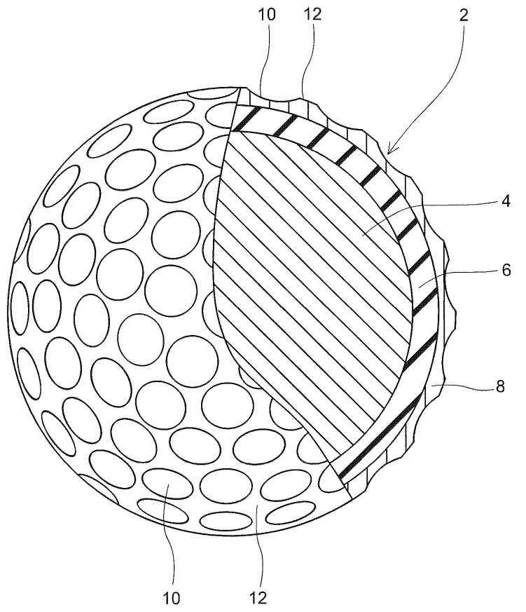

### FIELD OF THE DISCLOSURE

The present disclosure relates to a golf ball, and particularly relates to a golf ball comprising a spherical core, an intermediate layer and an outermost cover.

### DESCRIPTION OF THE RELATED ART

An iron shot is a shot for carrying a golf ball to the green or a target location, and focusing on the controllability of hitting the golf ball precisely on an aimed distance, not a flight distance itself. A flight distance of a golf ball is a sum of a distance (carry) and a distance (run). The distance (carry) is a distance from the point of hitting the golf ball to the point that the golf ball lands on the ground. The distance (run) is a distance from the point that the golf ball lands on the ground to the point that the golf ball stops after the golf ball rolls. Thus, it is necessary to control both the run and the carry for controlling the flight distance of the golf ball.

The face of a golf club has a loft angle. When a golf ball is hit with the golf club, the golf ball is launched at a launch angle corresponding to the loft angle. Furthermore, the loft angle creates a backspin to the golf ball. The golf ball flies while being accompanied with the backspin. If a backspin rate is high, the run is short. In other words, if a golf ball showing a high backspin rate is used, a player easily stops the golf ball at a target point. Thus, a golf ball with an excellent spin performance provides high controllability.

Conventionally, a golf ball having improved controllability has been proposed. For example, JP 2013-39361 A discloses a golf ball comprising a multi-layer core, and a cover having at least one layer, wherein the multi-layer core comprises (i) an inner core having a diameter in a range from about 0.015 inches to about 0.900 inches and a specific gravity in a range from about 1.18 g/cc to about 5.00 g/cc (SG ᵢₙₙₑᵣ), (ii) an intermediate core layer having a thickness in a range from about 0.100 inches to about 0.600 inches and a specific gravity in a range from about 0.080 g/cc to about 1.20 g/cc (SG _{intermediate}), and (iii) an outer core layer having a thickness in a range from about 0.010 inches to about 0.200 inches and a specific gravity in a range from about 1.18 g/cc to about 5.00 g/cc (SG ₒᵤₜₑᵣ), SG ᵢₙₙₑᵣ is greater than SG intermediate, and SG _{intermediate} is smaller than SGₒᵤₜₑᵣ.

In addition, JP S63-54181 A and JP S60-92780 A disclose a golf ball having a core, wherein a butyl rubber is used as a material constituting the core.

### SUMMARY OF THE DISCLOSURE

The run (rolling distance) on iron shots can be controlled by improving the spin performance and increasing the backspin rate of the golf ball. However, if the backspin rate increases, the golf ball flies up greatly and a maximum flying height is high, thus the golf ball tends to be affected by the wind. However, it is difficult for an average golfer to figure out the wind, thus the control of the flight distance on iron shots becomes difficult.

The present disclosure has been made in view of the above circumstances, and an object of the present disclosure is to provide a golf ball having improved controllability on iron shots.

The present disclosure that has solved the above problem provides a golf ball comprising a spherical core, an intermediate layer covering the spherical core, and an outermost cover covering the intermediate layer, wherein the spherical core is formed from a rubber composition containing a base rubber, a co-crosslinking agent, and a crosslinking initiator, the base rubber contains a polybutadiene rubber and a butyl rubber, an amount of the butyl rubber ranges from 10 mass % to 60 mass % in 100 mass % of the base rubber, a center hardness (H0) of the spherical core, a hardness (H_{2.5}) at a point having a radial distance of 2.5 mm from a center of the spherical core, a hardness (H_{5.0}) at a point having a radial distance of 5.0 mm from the center of the spherical core, a hardness (H_{7.5}) at a point having a radial distance of 7.5 mm from the center of the spherical core, a hardness (H₁₀) at a point having a radial distance of 10 mm from the center of the spherical core, a hardness (H_{12.5}) at a point having a radial distance of 12.5 mm from the center of the spherical core, and a hardness (H₁₅) at a point having a radial distance of 15 mm from the center of the spherical core satisfy a relationship of H0<H_{2.5}<H_{5.0}<H_{7.5}<H₁₀<H_{12.5}<H₁₅, a hardness difference (H₁₀−H0) between the hardness (H₁₀) at the point having the radial distance of 10 mm from the center of the spherical core and the center hardness (H0) is 10 or more in Shore C hardness, and a slab hardness of an intermediate layer composition forming the intermediate layer is greater than a slab hardness of a cover composition forming the outermost cover.

By using the predetermined amount of the butyl rubber in the base rubber forming the spherical core to control the hardness distribution of the spherical core, and controlling the hardness difference between the intermediate layer and the outermost cover, the golf ball according to the present disclosure shows an increased spin rate and a decreased maximum flying height on iron shots. Thus, the golf ball according to the present disclosure rolls in a decreased distance on iron shots, and is excellent in the controllability.

The golf ball according to the present disclosure has excellent controllability on iron shots.

### BRIEF DESCRIPTION OF THE DRAWINGS

The FIGURE is a partially cutaway cross-sectional view showing a golf ball according to the present disclosure.

### DESCRIPTION OF THE PREFERRED EMBODIMENT

The golf ball according to the present disclosure comprises a spherical core, an intermediate layer covering the spherical core, and an outermost cover covering the intermediate layer.

### (Spherical Core)

The spherical core is formed from a rubber composition containing a base rubber, a co-crosslinking agent, and a crosslinking initiator.

The base rubber contains a polybutadiene rubber and a butyl rubber.

As the polybutadiene rubber, a high-cis polybutadiene having a cis-1,4 bond in an amount of 40 mass % or more, preferably 80 mass % or more, more preferably 90 mass % or more, and even more preferably 95 mass % or more is preferred.

The amount of the 1,2-vinyl bond in the high-cis polybutadiene is preferably 2.0 mass % or less, more preferably 1.7 mass % or less, and even more preferably 1.5 mass % or less.

The high-cis polybutadiene is preferably one synthesized using a rare-earth element catalyst. When a neodymium catalyst employing a neodymium compound which is a lanthanum series rare-earth element compound, is used, a polybutadiene rubber having a high amount of the cis-1,4 bond and a low amount of the 1,2-vinyl bond is obtained with an excellent polymerization activity, and thus such polybutadiene rubber is particularly preferable.

The Mooney viscosity (ML₁₊₄ (100° C.)) of the high-cis polybutadiene is preferably 30 or more, more preferably 32 or more, and even more preferably 35 or more, and is preferably 140 or less, more preferably 120 or less, even more preferably 100 or less, and most preferably 55 or less. It is noted that the Mooney viscosity (ML₁₊₄ (100° C.)) in the present disclosure is a value measured according to JIS K6300 using an L rotor under the conditions of preheating time: 1 minute, rotor rotation time: 4 minutes, and temperature: 100° C.

The molecular weight distribution Mw/Mn (Mw: weight average molecular weight, Mn: number average molecular weight) of the high-cis polybutadiene is preferably 2.0 or more, more preferably 2.2 or more, even more preferably 2.4 or more, and most preferably 2.6 or more, and is preferably 6.0 or less, more preferably 5.0 or less, even more preferably 4.0 or less, and most preferably 3.0 or less. It is noted that the molecular weight distribution is measured by gel permeation chromatography (“HLC-8120GPC” available from Tosoh Corporation) using a differential refractometer as a detector under the conditions of column: GMHHXL (available from Tosoh Corporation), column temperature: 40° C., and mobile phase: tetrahydrofuran, and calculated by converting based on polystyrene standard.

The amount of the polybutadiene rubber in the base rubber is preferably 30 mass % or more, more preferably 35 mass % or more, and even more preferably 40 mass % or more, and is preferably 90 mass % or less, more preferably 85 mass % or less, and even more preferably 80 mass % or less.

The butyl rubber is a copolymer of isobutylene and isoprene.

The unsaturation degree of the butyl rubber is preferably 0.6 mole % or more, more preferably 0.8 mole % or more, and even more preferably 1.0 mole % or more, and is preferably 3.5 mole % or less, more preferably 3.3 mole % or less, and even more preferably 3.1 mole % or less.

The Mooney viscosity (ML₁₊₈ (125° C.)) of the butyl rubber is preferably 28 or more, more preferably 30 or more, and even more preferably 32 or more, and is preferably 60 or less, more preferably 58 or less, and even more preferably 56 or less. It is noted that the Mooney viscosity (ML₁₊₈ (125° C.)) in the present disclosure is a value measured using an L rotor under the conditions of preheating time: 1 minute, rotor rotation time: 8 minutes, and temperature: 125° C.

The amount of the butyl rubber in the base rubber is preferably 10 mass % or more, more preferably 15 mass % or more, and even more preferably 20 mass % or more, and is preferably 60 mass % or less, more preferably 55 mass % or less, and even more preferably 50 mass % or less. If the amount of the butyl rubber falls within the above range, the internal deformation of the spherical core is affected when hitting, and the spin rate increases and the ball initial velocity decreases on iron shots.

The mass ratio (polybutadiene rubber/butyl rubber) of the polybutadiene rubber to the butyl rubber in the base rubber is preferably 40/60 or more, more preferably 45/55 or more, and even more preferably 50/50 or more, and is preferably 90/10 or less, more preferably 85/15 or less, and even more preferably 80/20 or less.

The base rubber may consist of the polybutadiene rubber and the butyl rubber, or may further contain other rubbers. Examples of the other rubbers include a natural rubber, a polyisoprene rubber, a styrene-butadiene rubber, and an ethylene-propylene-diene rubber. When the other rubber is contained, the total amount of the polybutadiene rubber and the butyl rubber in the base rubber is preferably 75 mass % or more, more preferably 80 mass % or more, and even more preferably 85 mass % or more.

The co-crosslinking agent has an action of crosslinking a rubber molecule by graft polymerization to a base rubber molecular chain. The co-crosslinking agent may be used solely, or at least two of them may be used in combination. As the co-crosslinking agent, an α,β-unsaturated carboxylic acid having 3 to 8 carbon atoms and/or a metal salt thereof is preferable. Examples of the α,β-unsaturated carboxylic acid having 3 to 8 carbon atoms include acrylic acid, methacrylic acid, fumaric acid, maleic acid and crotonic acid.

Examples of the metal ion constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ions such as tin and zirconium. The above metal component may be used solely or as a mixture of at least two of them. Among them, the divalent metal ion such as magnesium, calcium, zinc, barium and cadmium is preferably used as the metal component. This is because if the divalent metal salt of the α,β-unsaturated carboxylic acid having 3 to 8 carbon atoms is used, a metal crosslinking easily generates between the rubber molecules. Especially, as the divalent metal salt, zinc acrylate is preferable, because zinc acrylate enhances the resilience of the obtained golf ball. It is noted that the α,β-unsaturated carboxylic acid having 3 to 8 carbon atoms and/or the metal salt thereof may be used solely, or at least two of them may be used in combination.

The amount of the co-crosslinking agent can be appropriately adjusted depending on the desired hardness of the spherical core. The amount of the co-crosslinking agent is preferably 15 parts by mass or more, more preferably 20 parts by mass or more, and even more preferably 25 parts by mass or more, is preferably 50 parts by mass or less, more preferably 45 parts by mass or less, and even more preferably 35 parts by mass or less, with respect to 100 parts by mass of the base rubber.

The crosslinking initiator is blended to crosslink the base rubber component. As the crosslinking initiator, an organic peroxide is suitable. Specific examples of the organic peroxide include dicumyl peroxide, 1,1-bis(t-butylperoxy)-3,3,5-trimethylcyclohexane, 2,5-dimethyl-2,5-di(t-butylperoxy) hexane and di-t-butyl peroxide. These organic peroxides may be used solely or as a mixture of at least two of them. Among them, dicumyl peroxide is preferably used.

The amount of the crosslinking initiator can be appropriately adjusted depending on the desired hardness of the spherical core. The amount of the crosslinking initiator is preferably 0.2 part by mass or more, more preferably 0.5 part by mass or more, and even more preferably 0.7 part by mass or more, and is preferably 5.0 parts by mass or less, more preferably 2.5 parts by mass or less, and even more preferably 2.0 parts by mass or less, with respect to 100 parts by mass of the base rubber.

In the case that the co-crosslinking agent of the rubber composition consists of the α,β-unsaturated carboxylic acid having 3 to 8 carbon atoms, the rubber composition preferably further contains a metal compound. If the α,β-unsaturated carboxylic acid having 3 to 8 carbon atoms is neutralized with the metal compound in the rubber composition, substantially the same effect as using the metal salt of the α,β-unsaturated carboxylic acid having 3 to 8 carbon atoms as the co-crosslinking agent is provided. In addition, in the case that the α,β-unsaturated carboxylic acid having 3 to 8 carbon atoms and the metal salt thereof are used in combination as the co-crosslinking agent, the metal compound may be used.

The metal compound is not particularly limited, as long as the metal compound can neutralize the α,β-unsaturated carboxylic acid having 3 to 8 carbon atoms in the rubber composition. Examples of the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate. As the metal compound, the divalent metal compound is preferable, the zinc compound is more preferable. This is because the divalent metal compound reacts with the α,β-unsaturated carboxylic acid having 3 to 8 carbon atoms to form a metal crosslinking. The metal compound may be used solely, or at least two of them may be used in combination.

The rubber composition may further contain an organic sulfur compound. The organic sulfur compound enhances the resilience of the spherical core. The organic sulfur compound is not particularly limited, as long as it is an organic compound having a sulfur atom in the molecule thereof. Examples of the organic sulfur compound include an organic compound having a thiol group (—SH) or a polysulfide bond having 2 to 4 sulfur atoms (—S—S—, —S—S—S—, or —S—S—S—S—), and a metal salt thereof (—SM, —S-M-S— or the like; M is a metal atom). The organic sulfur compound may be used solely or as a mixture of at least two of them.

Examples of the organic sulfur compound include thiophenols, thionaphthols, polysulfides, thiurams, thiocarboxylic acids, dithiocarboxylic acids, sulfenamides, dithiocarbamates, and thiazoles. As the organic sulfur compound, diphenyl disulfides (e.g. diphenyl disulfide, bis(pentabromophenyl)disulfide), thiophenols, and thionaphthols (e.g. 2-thionaphthol) are preferably used.

The amount of the organic sulfur compound can be appropriately adjusted depending on the desired resilience performance of the spherical core. For example, the amount of the organic sulfur compound is preferably 0.05 part by mass or more, more preferably 0.1 part by mass or more, and is preferably 5.0 parts by mass or less, more preferably 3.0 parts by mass or less, with respect to 100 parts by mass of the base rubber.

The rubber composition may further contain a carboxylic acid and/or a metal salt thereof. As the carboxylic acid and/or the metal salt thereof, a carboxylic acid having 1 to 30 carbon atoms and/or a metal salt thereof is preferable. As the carboxylic acid, an aliphatic carboxylic acid (a saturated fatty acid or an unsaturated fatty acid), or an aromatic carboxylic acid (such as benzoic acid) can be used. The amount of the carboxylic acid and/or the metal salt thereof is preferably 1 part by mass or more and 40 parts by mass or less with respect to 100 parts by mass of the base rubber.

The rubber composition may further contain an additive such as a filler for adjusting weight or the like, an antioxidant, a peptizing agent, and a softener, where necessary.

The filler blended in the rubber composition is mainly used as a weight adjusting agent for adjusting the weight of the golf ball obtained as a final product, and may be blended where necessary. Examples of the filler include an inorganic filler such as barium sulfate, calcium carbonate, magnesium oxide, tungsten powder, and molybdenum powder.

The rubber composition can be obtained by kneading the base rubber, the co-crosslinking agent, the crosslinking initiator, and the other optional components. The kneading method is not particularly limited. For example, the kneading can be conducted with a conventional kneading machine such as a kneading roll, a banbury mixer and a kneader.

The spherical core can be molded, for example, by heat pressing the core rubber composition. The molding conditions for heat pressing the core rubber composition may be determined appropriately depending on the rubber composition. Generally, the heat pressing is preferably carried out at a temperature of 130° C. to 200° C. for 10 to 60 minutes, or carried out in a two-step heating of heating at a temperature of 130° C. to 150° C. for 20 to 40 minutes followed by heating at a temperature of 160° C. to 180° C. for 5 to 15 minutes.

A center hardness (H0) of the spherical core, a hardness (H_{2.5}) at a point having a radial distance of 2.5 mm from a center of the spherical core, a hardness (H_{5.0}) at a point having a radial distance of 5.0 mm from the center of the spherical core, a hardness (H_{7.5}) at a point having a radial distance of 7.5 mm from the center of the spherical core, a hardness (H₁₀) at a point having a radial distance of 10 mm from the center of the spherical core, a hardness (H_{12.5}) at a point having a radial distance of 12.5 mm from the center of the spherical core, and a hardness (H₁₅) at a point having a radial distance of 15 mm from the center of the spherical core satisfy a relationship of H0<H_{2.5}<H_{5.0}<H_{7.5}<H₁₀<H_{12.5}<H₁₅, and a hardness difference (H₁₀−H0) between the hardness (H₁₀) at the point having the radial distance of 10 mm from the center of the spherical core and the center hardness (H0) is 10 or more in Shore C hardness. If the hardness distribution of the spherical core satisfies the above relationship, the spherical core smoothly deforms when hitting, and the shear force on iron shots can be effectively converted into the spin, thus the controllability becomes good.

The hardness difference (H₁₀−H0) between the hardness (H₁₀) at the point having the radial distance of 10 mm from the center of the spherical core and the center hardness (H0) of the spherical core is 10 or more, preferably 12 or more, more preferably 14 or more, and is preferably 25 or less, more preferably 23 or less, and even more preferably 21 or less in Shore C hardness.

A hardness difference (H_{12.5}−H_{5.0}) between the hardness (H_{12.5}) at the point having the radial distance of 12.5 mm from the center of the spherical core and the hardness (H_{5.0}) at the point having the radial distance of 5.0 mm from the center of the spherical core is preferably 5 or more, more preferably 6 or more, and even more preferably 7 or more in Shore C hardness. If the hardness difference (H_{12.5}−H_{5.0}) is 5 or more in Shore C hardness, the flight distance performance is better due to the low spin rate on driver shots. The hardness difference (H_{12.5}−H_{5.0}) is preferably 18 or less, more preferably 17 or less, and even more preferably 16 or less in Shore C hardness.

The center hardness (H0) of the spherical core is preferably 48 or more, more preferably 49 or more, and even more preferably 50 or more, and is preferably 60 or less, more preferably 59 or less, and even more preferably 58 or less in Shore C hardness.

The hardness (H_{5.0}) at the point having the radial distance of 5.0 mm from the center of the spherical core is preferably 56 or more, more preferably 58 or more, and even more preferably 60 or more, and is preferably 72 or less, more preferably 70 or less, and even more preferably 68 or less in Shore C hardness.

The hardness (H₁₀) at the point having the radial distance of 10 mm from the center of the spherical core is preferably 62 or more, more preferably 64 or more, and even more preferably 66 or more, and is preferably 78 or less, more preferably 76 or less, and even more preferably 74 or less in Shore C hardness.

The hardness (H_{12.5}) at the point having the radial distance of 12.5 mm from the center of the spherical core is preferably 66 or more, more preferably 68 or more, and even more preferably 70 or more, and is preferably 80 or less, more preferably 79 or less, and even more preferably 78 or less in Shore C hardness.

The hardness (H₁₅) at the point having the radial distance of 15 mm from the center of the spherical core is preferably 70 or more, more preferably 72 or more, and even more preferably 74 or more, and is preferably 85 or less, more preferably 83 or less, and even more preferably 81 or less in Shore C hardness.

The surface hardness (Hs) of the spherical core is preferably 70 or more, more preferably 72 or more, and even more preferably 74 or more, and is preferably 85 or less, more preferably 83 or less, and even more preferably 81 or less in Shore C hardness.

The diameter of the spherical core is preferably 34.8 mm or more, more preferably 36.8 mm or more, and even more preferably 38.0 mm or more, and is preferably 42.2 mm or less, more preferably 41.8 mm or less, even more preferably 41.2 mm or less, and most preferably 40.8 mm or less.

When the spherical core has a diameter in the range from 34.8 mm to 42.2 mm, the compression deformation amount of the spherical core (shrinking amount of the spherical core along the compression direction) when applying a load from an initial load of 98 N to a final load of 1275 N to the spherical core is preferably 2.0 mm or more, more preferably 2.5 mm or more, and even more preferably 3.0 mm or more, and is preferably 5.0 mm or less, more preferably 4.5 mm or less, and even more preferably 4.0 mm or less. If the compression deformation amount falls within the above range, the shot feeling is better.

### (Intermediate Layer)

The golf ball according to the present disclosure comprises an intermediate layer covering the spherical core.

The slab hardness (Hm) of the intermediate layer composition constituting the intermediate layer is preferably 50 or more, more preferably 53 or more, and even more preferably 55 or more in Shore D hardness. If the slab hardness (Hm) is 50 or more, the flight distance performance on driver shots is better. In addition, the slab hardness (Hm) is preferably 74 or less, more preferably 72 or less, and even more preferably 70 or less in Shore D hardness. If the slab hardness (Hm) is 74 or less, better shot feeling on shots is obtained. It is noted that in the case that the intermediate layer has a plurality of layers, the material hardness of the intermediate layer composition constituting the outermost intermediate layer is deemed as the material hardness Hm.

The thickness (Tm) of the intermediate layer is preferably 0.8 mm or more, more preferably 0.9 mm or more, and even more preferably 1.0 mm or more, and is preferably 3.0 mm or less, more preferably 2.6 mm or less, and even more preferably 2.2 mm or less. It is noted that in the case that the intermediate layer has a plurality of layers, the total thickness of all the intermediate layers is deemed as the thickness Tm of the intermediate layer.

### (Outermost Cover)

The golf ball according to the present disclosure comprises an outermost cover positioned outside the intermediate layer.

The slab hardness (Hc) of the cover composition constituting the outermost cover is preferably 40 or less, more preferably 38 or less, and even more preferably 36 or less in Shore D hardness. If the slab hardness (Hc) is 40 or less, the shot feeling on approach shots is better. In addition, the slab hardness (Hc) is preferably 20 or more, more preferably 22 or more, and even more preferably 24 or more in Shore D hardness. If the slab hardness (Hc) is 20 or more, the spin rate on driver shots does not become excessively great, and thus the flight distance performance is better.

The slab hardness (Hm) of the intermediate layer composition forming the intermediate layer is preferably greater than the slab hardness (Hc) of the cover composition forming the outermost cover. If the slab hardness (Hm) is greater than the slab hardness (Hc), the controllability of the golf ball can be further enhanced, and the spin rate on driver shots can be suppressed.

The hardness difference (Hm-Hc) between the slab hardness (Hm) and the slab hardness (Hc) is more than 0, preferably 5 or more, more preferably 10 or more, and is preferably 50 or less, more preferably 48 or less, and even more preferably 46 or less in Shore D hardness.

The thickness (Tc) of the outermost cover is preferably 0.4 mm or more, more preferably 0.5 mm or more, and even more preferably 0.6 mm or more, and is preferably 1.0 mm or less, more preferably 0.9 mm or less, and even more preferably 0.8 mm or less.

### (Cover Composition and Intermediate Layer Composition)

The outermost cover and the intermediate layer are preferably formed from a resin composition containing a base resin.

Examples of the base resin component used in the resin composition for forming the outermost cover and the intermediate layer include an ionomer resin, a urethane resin (a thermoplastic polyurethane elastomer, and a thermosetting polyurethane elastomer), a thermoplastic styrene elastomer, a thermoplastic polyamide elastomer, and a thermoplastic polyester elastomer.

Examples of the ionomer resin include a binary ionomer resin prepared by neutralizing at least a part of carboxyl groups in a binary copolymer composed of an olefin and an α,β-unsaturated carboxylic acid having 3 to 8 carbon atoms with a metal ion; a ternary ionomer resin prepared by neutralizing at least a part of carboxyl groups in a ternary copolymer composed of an olefin, an α,β-unsaturated carboxylic acid having 3 to 8 carbon atoms and an α,β-unsaturated carboxylic acid ester with a metal ion; and a mixture of those.

Examples of the binary ionomer resin include Himilan (registered trademark) 1555 (Na), 1557 (Zn), 1605 (Na), 1706 (Zn), 1707 (Na), AM7311 (Mg), AM7329 (Zn), AM7337 (available from Dow-Mitsui Polychemicals Co., Ltd.); Surlyn (registered trademark) 8945 (Na), 9945 (Zn), 8140 (Na), 8150 (Na), 9120 (Zn), 9150 (Zn), 6910 (Mg), 6120 (Mg), 7930 (Li), 7940 (Li), AD8546 (Li) (available from E.I. du Pont de Nemours and Company); and lotek (registered trademark) 8000 (Na), 8030 (Na), 7010 (Zn), 7030 (Zn) (available from ExxonMobil Chemical Corporation).

Examples of the ternary ionomer resin include Himilan AM7327 (Zn), 1855 (Zn), 1856 (Na), AM7331 (Na) (available from Dow-Mitsui Polychemicals Co., Ltd.); Surlyn 6320 (Mg), 8120 (Na), 8320 (Na), 9320 (Zn), 9320W (Zn), HPF1000 (Mg), HPF2000 (Mg) (available from E.I. du Pont de Nemours and Company); and lotek 7510 (Zn), 7520 (Zn) (available from ExxonMobil Chemical Corporation). It is noted that Na, Zn, Li, Mg or the like described in the parentheses after the trade names of the ionomer resin indicate a metal ion type for neutralizing the ionomer resin.

The urethane resin has a urethane bond in the molecule. The urethane bond may be formed by a reaction between a polyol and a polyisocyanate. The polyol which is the raw material for the urethane bond has a plurality of hydroxy groups, and a low molecular weight polyol or a high molecular weight polyol may be used.

Specific examples of the thermoplastic polyurethane elastomer include Elastollan (registered trademark) NY80A, NY84A, NY88A, NY95A, ET885, and ET890 (available from BASF Japan Ltd.).

As the thermoplastic styrene based elastomer, a thermoplastic elastomer containing a styrene block can be suitably used. The thermoplastic elastomer containing the styrene block has a polystyrene block that is a hard segment, and a soft segment.

The thermoplastic elastomer containing the styrene block includes a styrene-butadiene-styrene block copolymer (SBS), a styrene-isoprene-styrene block copolymer (SIS), a styrene-isoprene-butadiene-styrene block copolymer (SIBS), a hydrogenated product of SBS, a hydrogenated product of SIS, and a hydrogenated product of SIBS. Examples of the hydrogenated product of SBS include a styrene-ethylene-butylene-styrene block copolymer (SEBS). Examples of the hydrogenated product of SIS include a styrene-ethylene-propylene-styrene block copolymer (SEPS). Examples of the hydrogenated product of SIBS include a styrene-ethylene-ethylene-propylene-styrene block copolymer (SEEPS).

Examples of the thermoplastic styrene based elastomer include TEFABLOC (registered trademark) T3221C, T3339C, SJ4400N, SJ5400N, SJ6400N, SJ7400N, SJ8400N, SJ9400N, and SR04 (available from Mitsubishi Chemical Corporation).

The resin composition (cover composition) forming the outermost cover preferably contains the urethane resin and/or the ionomer resin as the base resin, particularly contains the urethane resin as the base resin. If the outermost cover contains the urethane resin as the base resin, the spin performance of the golf ball is further enhanced, and particularly the spin rate on approach shots is further increased.

When the cover composition contains the urethane resin as the base resin, the amount of the urethane resin in the base resin is preferably 50 mass % or more, more preferably 60 mass % or more, and even more preferably 70 mass % or more. The base resin of the cover composition may consist of the urethane resin (preferably the thermoplastic urethane elastomer).

When the cover composition contains the ionomer resin as the base resin, the amount of the ionomer resin in the base resin is preferably 50 mass % or more, more preferably 60 mass % or more, and even more preferably 70 mass % or more. When the ionomer resin is contained, the thermoplastic styrene elastomer is also preferably used in combination.

The resin composition (intermediate layer composition) forming the intermediate layer preferably contains the ionomer resin as the base resin. If the intermediate layer composition contains the ionomer resin, the resilience performance of the golf ball is enhanced, and particularly the resilience performance on driver shots is excellent. The amount of the ionomer resin in the base resin of the intermediate layer composition is preferably 50 mass % or more, more preferably 60 mass % or more, and even more preferably 70 mass % or more. When the ionomer resin is contained, the thermoplastic styrene elastomer is also preferably used in combination.

The resin composition forming the outermost cover and the intermediate layer may contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, a fluorescent material or fluorescent brightener, or the like, in addition to the above base resin.

The amount of the white pigment (e.g. titanium oxide) is preferably 0.5 part by mass or more, more preferably 1 part by mass or more, and is preferably 10 parts by mass or less, more preferably 8 parts by mass or less, with respect to 100 parts by mass of the base resin. If the amount of the white pigment is 0.5 part by mass or more, it is possible to impart the opacity to the intermediate layer or outermost cover. In addition, if the amount of the white pigment is 10 parts by mass or less, the obtained intermediate layer and outermost cover have better durability.

The method for molding the intermediate layer is not particularly limited, and examples thereof include a method which comprises molding the intermediate layer composition into a half shell in advance, covering the spherical core with two of the half shells, and performing compression molding; and a method which comprises injection molding the intermediate layer composition directly onto the spherical core to cover the spherical core.

Examples of the method for molding the cover include a method which comprises molding the cover composition into a hollow shell, covering the spherical body (the spherical core or the spherical body having the intermediate layer formed) with a plurality of the shells, and performing compression molding (preferably a method which comprises molding the cover composition into a hollow half-shell, covering the spherical body with two of the half-shells, and performing compression molding); and a method which comprises directly injection molding the cover composition directly onto the spherical body.

The golf ball body having the cover formed thereon is ejected from the mold, and is preferably subjected to surface treatments such as deburring, cleaning and sandblast where necessary.

In addition, if desired, a paint film or a mark may be formed. The thickness of the paint film is not particularly limited, and is preferably 5 μm or more, more preferably 6 μm or more, and even more preferably 7 μm or more, and is preferably 50 μm or less, more preferably 40 μm or less, and even more preferably 30 μm or less. If the thickness of the paint film is 5 μm or more, the paint film is hard to wear off even if the golf ball is used continuously, and if the thickness of the paint film is 50 μm or less, the dimple effect is fully obtained. It is noted that the effect of the present disclosure is not impaired by the paint film, since the paint film is very thin.

### (Construction of Golf Ball)

The golf ball according to the present disclosure comprises a spherical core, an intermediate layer covering the spherical core, and an outermost cover covering the intermediate layer. Examples of the construction of the golf ball include a three-piece golf ball composed of a single-layered spherical core, a single-layered intermediate layer covering the spherical core, and an outermost cover covering the intermediate layer; and a multi-piece golf ball (such as a four-piece golf ball, a five-piece golf ball or the like) composed of a single-layered spherical core, at least two intermediate layers covering the spherical core, and an outermost cover covering the intermediate layers.

The golf ball according to the present disclosure preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball according to the present disclosure preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

When the golf ball has a diameter in the range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.1 mm or more, and even more preferably 2.2 mm or more, and is preferably 3.0 mm or less, more preferably 2.9 mm or less, and even more preferably 2.8 mm or less. If the compression deformation amount falls within the above range, the golf ball has better shot feeling.

The surface hardness of the golf ball is preferably 45 or more, more preferably 48 or more, and even more preferably 50 or more, and is preferably 65 or less, more preferably 63 or less, and even more preferably 61 or less in Shore D hardness. If the surface hardness of the golf ball falls within the above range, the impact resistance is excellent and the surface is hardly damaged.

The FIGURE shows one example of the golf ball according to the present disclosure. The FIGURE is a partially cutaway cross-sectional view showing a golf ball 2 according to one embodiment of the present disclosure. The golf ball 2 comprises a spherical core 4, an intermediate layer 6 covering the spherical core 4, and an outermost cover 8 covering the intermediate layer 6. A plurality of dimples 10 are formed on the surface of the outermost cover 8. Other portions than the dimples 10 on the surface of the golf ball are lands 12. The golf ball 2 is provided with a paint layer and a mark layer on an outer side of the outermost cover 8, but these layers are not depicted.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Compression Deformation Amount (mm)

The compression deformation amount was measured with a YAMADA type compression tester “SCH”. The golf ball or spherical core was placed on a metal rigid plate of the tester. A metal cylinder slowly fell toward the golf ball or spherical core. The golf ball or spherical core sandwiched between the bottom of the cylinder and the rigid plate deformed. The travelling distance of the cylinder when applying a load from an initial load of 98 N to a final load of 1275 N to the golf ball or spherical core was measured. The compression deformation amount (mm) is the travelling distance. The travelling speed of the cylinder before applying the initial load was 0.83 mm/s. The travelling speed of the cylinder when applying the load from the initial load to the final load was 1.67 mm/s.

### (2) Core Hardness (Shore C Hardness)

The hardness measured at the surface portion of the core was adopted as the surface hardness of the core. In addition, the core was cut into two hemispheres to obtain a cut plane, and the hardness at the central point of the cut plane and the hardness at the predetermined distance from the central point in the radius direction were measured. It is noted that each hardness was measured at four points, and the average value thereof was calculated. An automatic hardness tester (Digitest II, available from Bareiss company) using a testing device of “Shore C” was used to measure the hardness.

### (3) Slab Hardness (Shore D Hardness)

Sheets with a thickness of about 2 mm were produced by injection molding the resin composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (4) Surface Hardness of Golf Ball

The hardness measured at the land portion of the golf ball surface was adopted as the surface hardness of the ball. The hardness was measured at four points, and the average value thereof was calculated. An automatic hardness tester (Digitest II, available from Bareiss company) using a testing device of “Shore D” was used to measure the hardness.

### (5) 7-Iron Test (I #7 Shot)

A 7-iron (“XXIO12”, Shaft hardness: S, Loft angle: 28°, available from Sumitomo Rubber Industries, Ltd.) was installed on a swing machine available from Golf Laboratories, Inc. The hitting point was set at the face center. The golf ball was hit under a condition of a head speed of 33 m/sec, and the ball velocity and spin rate right after hitting the golf ball and the maximum flying height were measured. The measurement was conducted twelve times for each golf ball, and the average value thereof was adopted as the measurement value for the golf ball. The ball velocity and spin rate were measured by continuously taking a sequence of photographs of the golf ball right after hitting the golf ball. The maximum flying height was measured with a launch monitor “TRACK MAN 4” available from TRACK MAN Golf.

### [Production of Golf Ball]

### (1) Production of Spherical Core

According to the formulations shown in Table 1, the materials were kneaded with a kneading roll to obtain the core compositions.

The core compositions shown in Table 1 were heat pressed in upper and lower molds, each having a hemispherical cavity, to obtain the spherical cores. It is noted that barium sulfate was added in an appropriate amount such that the obtained golf balls had a mass of 45.3 g.

TABLE 1-1

| Spherical core No. | | A1 | A2 | B1 | B2 |
|---|---|---|---|---|---|
| Formulation | Polybutadiene rubber | 70 | 70 | 55 | 55 |
| (parts by | Butyl rubber | 30 | 30 | 45 | 45 |
| mass) | Zinc acrylate | 25 | 25 | 26 | 26 |
| | Zinc oxide | 5 | 5 | 5 | 5 |
| | Barium sulfate | Appropriate | Appropriate | Appropriate | Appropriate |
| | | amount*¹⁾ | amount*¹⁾ | amount*¹⁾ | amount*¹⁾ |
| | Benzoic acid | — | — | — | — |
| | Bis(pentabromophenyl) disulfide | — | — | — | — |
| | Diphenyl disulfide | — | — | — | — |
| | Dicumyl peroxide | 0.7 | 0.7 | 0.7 | 0.7 |
| Molding | Vulcanizing temperature (° C.) | 150 | 150 | 150 | 150 |
| condition | Vulcanizing time (min) | 20 | 20 | 20 | 20 |
| Diameter (mm) | | 39.5 | 39.1 | 39.5 | 38.5 |
| Compression deformation amount (mm) | | 3.15 | 3.17 | 3.22 | 3.29 |
| Hardness | Center hardness (H0) | 57.2 | 56.9 | 56.8 | 56.2 |
| distribution | Hardness at 2.5 mm point from | 59.8 | 59.6 | 58.6 | 58.1 |
| (Shore C) | center (H_{2.5}) | | | | |
| | Hardness at 5.0 mm point from | 63.1 | 62.8 | 61.8 | 61.2 |
| | center (H_{5.0}) | | | | |
| | Hardness at 7.5 mm point from | 65.4 | 65.1 | 66.2 | 65.7 |
| | center (H_{7.5}) | | | | |
| | Hardness at 10 mm point from | 73.9 | 73.1 | 72.6 | 72.0 |
| | center (H₁₀) | | | | |
| | Hardness at 12.5 mm point from | 77.1 | 76.7 | 76.2 | 75.8 |
| | center (H_{12.5}) | | | | |
| | Hardness at 15 mm point from | 80.6 | 79.9 | 79.4 | 78.6 |
| | center (H₁₅) | | | | |
| | Surface hardness (Hs) | 79.1 | 78.8 | 78.3 | 77.9 |
| Spherical core No. | | C | D | E | F |
| Formulation | Polybutadiene rubber | 60 | 100 | 100 | 100 |
| (parts by | Butyl rubber | 40 | — | — | — |
| mass) | Zinc acrylate | 29 | 34.3 | 30.6 | 33.2 |
| | Zinc oxide | 5 | 5 | 5 | 10 |
| | Barium sulfate | Appropriate | Appropriate | Appropriate | Appropriate |
| | | amount*¹⁾ | amount*¹⁾ | amount*¹⁾ | amount*¹⁾ |
| | Benzoic acid | — | — | — | 2 |
| | Bis(pentabromophenyl) disulfide | — | — | 0.4 | 0.4 |
| | Diphenyl disulfide | — | 0.4 | — | — |
| | Dicumyl peroxide | 0.7 | 0.7 | 0.7 | 0.7 |
| Molding | Vulcanizing temperature (° C.) | 170 | 150 | 155 | 170 |
| condition | Vulcanizing time (min) | 18 | 20 | 20 | 15 |
| Diameter (mm) | | 39.5 | 39.5 | 39.5 | 39.5 |
| Compression deformation amount (mm) | | 3.21 | 3.18 | 3.16 | 3.20 |
| Hardness | Center hardness (H0) | 57.8 | 70.7 | 64.8 | 55.4 |
| distribution | Hardness at 2.5 mm point from | 65.1 | 71.9 | 67.7 | 65.1 |
| (Shore C) | center (H_{2.5}) | | | | |
| | Hardness at 5.0 mm point from | 68.6 | 72.5 | 69.3 | 69.6 |
| | center (H_{5.0}) | | | | |
| | Hardness at 7.5 mm point from | 72.2 | 73.0 | 69.9 | 70.2 |
| | center (H_{7.5}) | | | | |
| | Hardness at 10 mm point from | 72.4 | 75.5 | 72.6 | 70.6 |
| | center (H₁₀) | | | | |
| | Hardness at 12.5 mm point from | 75.4 | 77.1 | 75.1 | 71.0 |
| | center (H_{12.5}) | | | | |
| | Hardness at 15 mm point from | 80.9 | 77.7 | 79.8 | 76.7 |
| | center (H₁₅) | | | | |
| | Surface hardness (Hs) | 84.9 | 79.3 | 82.2 | 86.2 |

*¹⁾The amount of barium sulfate was adjusted such that the golf balls had a mass of 45.3 g.

The materials used in Table 1 are shown as follows.
Polybutadiene rubber: “BR-730” (high-cis polybutadiene rubber, amount of cis-1,4 bond: 95 mass %, amount of 1,2-vinyl bond: 1.3 mass %, Moony viscosity (ML₁₊₄ (100° C.): 55, molecular weight distribution (Mw/Mn): 3) available from JSR Corporation
Butyl rubber: “Butyl 268” (unsaturation degree: 1.5 mole %, Moony viscosity (ML₁₊₈ (125° C.): 51) available from Japan Butyl Co. Ltd.
Zinc acrylate: “ZN-DA90S” available from Nisshoku Techno Fine Chemical Co., Ltd.
Zinc oxide: “Ginrei R” available from Toho Zinc Co., Ltd.
Barium sulfate: “Barium sulfate BD” available from Sakai Chemical Industry Co., Ltd.
Benzoic acid: (purity: at least 98%) available from Tokyo Chemical Industry Co. Ltd.
Bis(pentabromophenyl) disulfide: available from Kawaguchi Chemical Industry Co., Ltd.
Diphenyl disulfide: available from Sumitomo Seika Chemicals Co., Ltd.
Dicumyl peroxide: “Percumyl (registered trademark) D” available from NOF Corporation

### (2) Preparation of Resin Composition (Intermediate Layer Composition and Cover Composition)

According to the formulations shown in Table 2, the materials were extruded with a twin-screw kneading type extruder to prepare the resin compositions in a pellet form.

TABLE 2

| | | Resin composition No. | | | | | | |
|---|---|---|---|---|---|---|---|---|
| | | a | b | c | d | e | f | g |
| Formulation | Surlyn 8150 | 50 | — | — | — | — | — | — |
| (parts by | Himilan 1605 | — | 47 | — | — | — | — | — |
| mass) | Himilan AM7329 | 50 | 50 | — | — | — | — | — |
| | Himilan 1555 | — | — | 45 | 41 | — | — | — |
| | Himilan 1557 | — | — | 45 | 41 | — | — | — |
| | TEFABLOC | — | 3 | 10 | 18 | — | — | — |
| | T3221C | | | | | | | |
| | Elastollan | — | — | — | — | 100 | — | — |
| | NY80A | | | | | | | |
| | Elastollan | — | — | — | — | — | 100 | — |
| | NY84A | | | | | | | |
| | Elastollan | — | — | — | — | — | — | 50 |
| | NY88A | | | | | | | |
| | Elastollan | — | — | — | — | — | — | 50 |
| | NY95A | | | | | | | |
| | Tinuvin 770 | — | — | — | — | 0.2 | 0.2 | 0.2 |
| | Titanium dioxide | 4 | 4 | 4 | 4 | 4 | 4 | 4 |

| | | | | | | | |
|---|---|---|---|---|---|---|---|
| Slab hardness (Shore D) | 68 | 63 | 55 | 50 | 27 | 31 | 40 |

Surlyn (registered trademark) 8150: sodium ion neutralized ethylene-methacrylic acid copolymer ionomer resin available from E.I. du Pont de Nemours and Company
Himilan (registered trademark) 1605: sodium ion neutralized ethylene-methacrylic acid copolymer ionomer resin available from Dow-Mitsui Polychemicals Co., Ltd.
Himilan (registered trademark) AM7329: sodium ion neutralized ethylene-methacrylic acid copolymer ionomer resin available from Dow-Mitsui Polychemicals Co., Ltd.
Himilan (registered trademark) 1555: sodium ion neutralized ethylene-methacrylic acid copolymer ionomer resin available from Dow-Mitsui Polychemicals Co., Ltd.
Himilan (registered trademark) 1557: zinc ion neutralized ethylene-methacrylic acid copolymer ionomer resin available from Dow-Mitsui Polychemicals Co., Ltd.
TEFABLOC (registered trademark) T3221C: thermoplastic styrene based elastomer available from Mitsubishi Chemical Corporation
Elastollan (registered trademark) NY80A: thermoplastic polyurethane elastomer available from BASF Japan Ltd.
Elastollan (registered trademark) NY84A: thermoplastic polyurethane elastomer available from BASF Japan Ltd.
Elastollan (registered trademark) NY88A: thermoplastic polyurethane elastomer available from BASF Japan Ltd.
Elastollan (registered trademark) NY95A: thermoplastic polyurethane elastomer available from BASF Japan Ltd.
Tinuvin (registered trademark) 770: hindered amine-based light stabilizer available from BASF Japan Ltd.
Titanium dioxide: A-220 available from Ishihara Sangyo Kaisha, Ltd.

### (3) Formation of Intermediate Layer and Cover

The resin composition (intermediate layer composition) was injection molded on the spherical core to obtain the intermediate layer-covering spherical body. The obtained intermediate layer-covering spherical body was charged into a final mold provided with a plurality of pimples on the cavity surface. Half shells were obtained from the resin composition (cover composition) by a compression molding method. The intermediate layer-covering spherical body was covered with two of the half shells and charged into the final mold to obtain the golf balls having an outermost cover. A plurality of dimples with an inverted shape of the pimple shape on the cavity surface were formed on the outermost cover. The evaluation results regarding the obtained golf balls are shown in Table 3.

TABLE 3-1

| Golf ball No. | | 1 | 2 | 3 | 4 | 5 | 6 |
|---|---|---|---|---|---|---|---|
| Spherical | No. | A1 | B1 | C | A1 | A1 | A2 |
| core | Diameter (mm) | 39.5 | 39.5 | 39.5 | 39.5 | 39.5 | 39.1 |
| | Compression deformation amount (mm) | 3.15 | 3.22 | 3.21 | 3.15 | 3.15 | 3.17 |
| Hardness | Hardness difference (H_{2.5} − H0) | 2.6 | 1.8 | 7.3 | 2.6 | 2.6 | 2.7 |
| difference | Hardness difference (H_{5.0} − H_{2.5}) | 3.3 | 3.2 | 3.5 | 3.3 | 3.3 | 3.2 |
| (Shore C) | Hardness difference (H_{7.5} − H_{5.0}) | 2.3 | 4.4 | 3.6 | 2.3 | 2.3 | 2.3 |
| | Hardness difference (H₁₀ − H_{7.5}) | 8.5 | 6.4 | 0.2 | 8.5 | 8.5 | 8.0 |
| | Hardness difference (H_{12.5} − H₁₀) | 3.2 | 3.6 | 3.0 | 3.2 | 3.2 | 3.6 |
| | Hardness difference (H₁₅ − H_{12.5}) | 3.5 | 3.2 | 5.5 | 3.5 | 3.5 | 3.2 |
| | Hardness difference (Hs − H₁₅) | −1.5 | −1.1 | 4.0 | −1.5 | −1.5 | −1.1 |
| | Hardness difference (H₁₀ − H0) | 16.7 | 15.8 | 14.6 | 16.7 | 16.7 | 16.2 |
| | Hardness difference (H_{12.5} − H_{5.0}) | 14.0 | 14.4 | 6.8 | 14.0 | 14.0 | 13.9 |
| Intermediate | Resin composition No. | a | a | a | b | c | a |
| layer | Thickness (mm) | 1.0 | 1.0 | 1.0 | 1.0 | 1.0 | 1.0 |
| | Slab hardness (Shore D) | 68 | 68 | 68 | 63 | 55 | 68 |
| Cover | Resin composition No. | f | f | f | g | e | f |
| | Thickness (mm) | 0.6 | 0.6 | 0.6 | 0.6 | 0.6 | 0.8 |
| | Slab hardness (Shore D) | 31 | 31 | 31 | 40 | 27 | 31 |
| Golf ball | Surface hardness (Shore D) | 59 | 59 | 59 | 60 | 52 | 56 |
| | Compression deformation amount (mm) | 2.72 | 2.79 | 2.78 | 2.74 | 2.79 | 2.74 |
| I#7 | Spin rate (rpm) | 5120 | 5170 | 5060 | 5010 | 5290 | 5310 |
| shot | Ball velocity (m/s) | 46.7 | 45.8 | 46.2 | 46.6 | 46.4 | 46.7 |
| | Maximum flying height (m) | 28.2 | 27.2 | 27.6 | 27.9 | 28.1 | 28.4 |

| Golf ball No. | | 7 | 8 | 9 | 10 | 11 | 12 | 13 |
|---|---|---|---|---|---|---|---|---|
| Spherical | No. | B2 | D | E | F | A1 | E | E |
| core | Diameter (mm) | 38.5 | 39.5 | 39.5 | 39.5 | 39.5 | 39.5 | 39.5 |
| | Compression deformation amount (mm) | 3.29 | 3.18 | 3.16 | 3.20 | 3.15 | 3.16 | 3.16 |
| Hardness | Hardness difference (H_{2.5} − H0) | 1.9 | 1.2 | 2.9 | 9.7 | 2.6 | 2.9 | 2.9 |
| difference | Hardness difference (H_{5.0} − H_{2.5}) | 3.1 | 0.6 | 1.6 | 4.5 | 3.3 | 1.6 | 1.6 |
| (Shore C) | Hardness difference (H_{7.5} − H_{5.0}) | 4.5 | 0.5 | 0.6 | 0.6 | 2.3 | 0.6 | 0.6 |
| | Hardness difference (H₁₀ − H_{7.5}) | 6.3 | 2.5 | 2.7 | 0.4 | 8.5 | 2.7 | 2.7 |
| | Hardness difference (H_{12.5} − H₁₀) | 3.8 | 1.6 | 2.5 | 0.4 | 3.2 | 2.5 | 2.5 |
| | Hardness difference (H₁₅ − H_{12.5}) | 2.8 | 0.6 | 4.7 | 5.7 | 3.5 | 4.7 | 4.7 |
| | Hardness difference (Hs − H₁₅) | −0.7 | 1.6 | 2.4 | 9.5 | −1.5 | 2.4 | 2.4 |
| | Hardness difference (H₁₀ − H0) | 15.8 | 4.8 | 7.8 | 15.2 | 16.7 | 7.8 | 7.8 |
| | Hardness difference (H_{12.5} − H_{5.0}) | 14.6 | 4.6 | 5.8 | 1.4 | 14.0 | 5.8 | 5.8 |
| Intermediate | Resin composition No. | a | a | a | a | d | d | d |
| layer | Thickness (mm) | 1.3 | 1.0 | 1.0 | 1.0 | 1.0 | 1.0 | 1.0 |
| | Slab hardness (Shore D) | 68 | 68 | 68 | 68 | 50 | 50 | 50 |
| Cover | Resin composition No. | f | f | f | f | c | b | c |
| | Thickness (mm) | 0.8 | 0.6 | 0.6 | 0.6 | 0.6 | 0.6 | 0.6 |
| | Slab hardness (Shore D) | 31 | 31 | 31 | 31 | 55 | 63 | 55 |
| Golf ball | Surface hardness (Shore D) | 56 | 59 | 59 | 59 | 53 | 53 | 53 |
| | Compression deformation amount (mm) | 2.76 | 2.73 | 2.71 | 2.75 | 2.68 | 2.62 | 2.66 |
| I#7 | Spin rate (rpm) | 5340 | 4970 | 4750 | 4520 | 4700 | 4170 | 4310 |
| shot | Ball velocity (m/s) | 45.9 | 48.8 | 48.9 | 48.9 | 47.2 | 49.1 | 49.1 |
| | Maximum flying height (m) | 27.5 | 30.6 | 30.5 | 30.2 | 28.5 | 29.9 | 30.1 |

The golf balls No. 1 to 7 are the cases that the spherical core is formed from a rubber composition containing a polybutadiene rubber and a butyl rubber in a predetermined amount, and has a hardness distribution satisfying a relationship of H0<H_{2.5}<H_{5.0}<H_{7.5}<H₁₀<H_{12.5}<H₁₅ and a hardness difference (H₁₀−H0) being 10 or more in Shore C hardness, and a slab hardness of an intermediate layer composition is greater than a slab hardness of a cover composition. These golf balls No. 1 to 7 had high spin performance and a suppressed maximum flying height on iron shots, and thus have improved controllability.

The golf balls No. 8 to 10, 12 and 13 are the cases that the spherical core is formed from a rubber composition not containing a butyl rubber.

The golf ball No. 11 is the case that a slab hardness of an intermediate layer composition is smaller than a slab hardness of a cover composition, although the spherical core is formed from a rubber composition containing a polybutadiene rubber and a butyl rubber in a predetermined amount, and has a hardness distribution satisfying a relationship of H0<H_{2.5}<H_{5.0}<H_{7.5}<H₁₀<H_{12.5}<H₁₅ and a hardness difference (H₁₀−H0) being 10 or more in Shore C hardness.

These golf balls No. 8 to 13 had low spin performance and did not control a maximum flying height, and thus did not improve controllability.

### Embodiments of the Present Disclosure

The present disclosure (1) is a golf ball comprising a spherical core, an intermediate layer covering the spherical core, and an outermost cover covering the intermediate layer, wherein the spherical core is formed from a rubber composition containing a base rubber, a co-crosslinking agent, and a crosslinking initiator, the base rubber contains a polybutadiene rubber and a butyl rubber, an amount of the butyl rubber ranges from 10 mass % to 60 mass % in 100 mass % of the base rubber, a center hardness (H0) of the spherical core, a hardness (H_{2.5}) at a point having a radial distance of 2.5 mm from a center of the spherical core, a hardness (H_{5.0}) at a point having a radial distance of 5.0 mm from the center of the spherical core, a hardness (H_{7.5}) at a point having a radial distance of 7.5 mm from the center of the spherical core, a hardness (H₁₀) at a point having a radial distance of 10 mm from the center of the spherical core, a hardness (H_{12.5}) at a point having a radial distance of 12.5 mm from the center of the spherical core, and a hardness (H₁₅) at a point having a radial distance of 15 mm from the center of the spherical core satisfy a relationship of H0<H_{2.5}<H_{5.0}<H_{7.5}<H₁₀<H_{12.5}<H₁₅, a hardness difference (H₁₀−H0) between the hardness (H₁₀) at the point having the radial distance of 10 mm from the center of the spherical core and the center hardness (H0) is 10 or more in Shore C hardness, and a slab hardness of an intermediate layer composition forming the intermediate layer is greater than a slab hardness of a cover composition forming the outermost cover.

The present disclosure (2) is the golf ball according to the present disclosure (1), wherein a hardness difference (H_{12.5}−H_{5.0}) between the hardness (H_{12.5}) at the point having the radial distance of 12.5 mm from the center of the spherical core and the hardness (H_{5.0}) at the point having the radial distance of 5.0 mm from the center of the spherical core is 5 or more in Shore C hardness.

The present disclosure (3) is the golf ball according to the present disclosure (1) or (2), wherein the center hardness (H0) of the spherical core is 60 or less in Shore C hardness.

The present disclosure (4) is the golf ball according to any one of the present disclosures (1) to (3), wherein the intermediate layer composition forming the intermediate layer is a resin composition containing an ionomer resin as a base resin, and the cover composition forming the outermost cover is a resin composition containing a urethane resin as a base resin.

The present disclosure (5) is the golf ball according to any one of the present disclosures (1) to (4), wherein the slab hardness of the cover composition forming the outermost cover is 40 or less in Shore D hardness.

The present disclosure (6) is the golf ball according to any one of the present disclosures (1) to (5), wherein the slab hardness of the intermediate layer composition forming the intermediate layer is 50 or more in Shore D hardness.

This application is based on Japanese patent application No. 2023-127133 filed on Aug. 3, 2023, the content of which is hereby incorporated by reference.

1. A golf ball comprising a spherical core, an intermediate layer covering the spherical core, and an outermost cover covering the intermediate layer, wherein
the spherical core is formed from a rubber composition containing a base rubber, a co-crosslinking agent, and a crosslinking initiator,
the base rubber contains a polybutadiene rubber and a butyl rubber,
an amount of the butyl rubber ranges from 10 mass % to 60 mass % in 100 mass % of the base rubber,
a center hardness (H0) of the spherical core, a hardness (H_{2.5}) at a point having a radial distance of 2.5 mm from a center of the spherical core, a hardness (H_{5.0}) at a point having a radial distance of 5.0 mm from the center of the spherical core, a hardness (H_{7.5}) at a point having a radial distance of 7.5 mm from the center of the spherical core, a hardness (H₁₀) at a point having a radial distance of 10 mm from the center of the spherical core, a hardness (H_{12.5}) at a point having a radial distance of 12.5 mm from the center of the spherical core, and a hardness (H₁₅) at a point having a radial distance of 15 mm from the center of the spherical core satisfy a relationship of H0<H_{2.5}<H_{5.0}<H_{7.5}<H₁₀<H_{12.5}<H₁₅,
a hardness difference (H₁₀−H0) between the hardness (H₁₀) at the point having the radial distance of 10 mm from the center of the spherical core and the center hardness (H0) is 10 or more in Shore C hardness, and
a slab hardness of an intermediate layer composition forming the intermediate layer is greater than a slab hardness of a cover composition forming the outermost cover.

2. The golf ball according to claim 1, wherein a hardness difference (H_{12.5}−H_{5.0}) between the hardness (H_{12.5}) at the point having the radial distance of 12.5 mm from the center of the spherical core and the hardness (H_{5.0}) at the point having the radial distance of 5.0 mm from the center of the spherical core is 5 or more in Shore C hardness.

3. The golf ball according to claim 1, wherein the center hardness (H0) of the spherical core is 60 or less in Shore C hardness.

4. The golf ball according to claim 1, wherein the intermediate layer composition forming the intermediate layer is a resin composition containing an ionomer resin as a base resin, and
the cover composition forming the outermost cover is a resin composition containing a urethane resin as a base resin.

5. The golf ball according to claim 1, wherein the slab hardness of the cover composition forming the outermost cover is 40 or less in Shore D hardness.

6. The golf ball according to claim 1, wherein the slab hardness of the intermediate layer composition forming the intermediate layer is 50 or more in Shore D hardness.

7. The golf ball according to claim 1, wherein the hardness (H_{5.0}) at the point having the radial distance of 5.0 mm from the center of the spherical core ranges from 56 to 72 in Shore C hardness.

8. The golf ball according to claim 1, wherein the hardness (H₁₀) at the point having the radial distance of 10 mm from the center of the spherical core ranges from 62 to 78 in Shore C hardness.

9. The golf ball according to claim 1, wherein the hardness (H_{12.5}) at the point having the radial distance of 12.5 mm from the center of the spherical core ranges from 66 to 80 in Shore C hardness.

10. The golf ball according to claim 1, wherein the hardness (H₁₅) at the point having the radial distance of 15 mm from the center of the spherical core ranges from 70 to 85 in Shore C hardness.

11. The golf ball according to claim 1, wherein a surface hardness (Hs) of the spherical core ranges from 70 to 85 in Shore C hardness.

12. The golf ball according to claim 1, wherein the hardness difference (H₁₀−H0) ranges from 10 to 25 in Shore C hardness.

13. The golf ball according to claim 2, wherein the hardness difference (H_{12.5}−H_{5.0}) ranges from 5 to 18 in Shore C hardness.

14. The golf ball according to claim 1, wherein a mass ratio (polybutadiene rubber/butyl rubber) of the polybutadiene rubber to the butyl rubber ranges from 40/60 to 90/10.

15. The golf ball according to claim 1, wherein the butyl rubber has a Mooney viscosity (ML₁₊₈ (125° C.)) ranging from 28 to 60.

16. The golf ball according to claim 1, wherein a hardness difference (Hm-Hc) between the slab hardness (Hm) of the intermediate layer and the slab hardness (Hc) of the cover composition is more than 0 and 50 or less in Shore D hardness.
